(19) United States
(12) Patent Application Publication
(10) Pub. No.: US 2009/0277577 A1
(43) Pub. Date: Nov. 12, 2009

(54) USE OF A HALOGEN-FREE FILM IN AN ADHESIVE MASKING TAPE, THE FILM BEING TEARABLE TRANSVERSELY AS A RESULT OF ELECTRON BEAM IRRADIATION

(75) Inventors: Nicolai Böhm, Hamburg (DE); Siegfried Krupke, Tomesch (DE)

Correspondence Address: NORRIS, MCLAUGHLIN & MARCUS, P.A., 875 THIRD AVE, 18TH FLOOR, NEW YORK, NY, 10022, US

(73) Assignee: TESA AG, HAMBURG (DE)

(21) Appl. No.: 12/300,728

(22) PCT Filed: May 16, 2007
(86) PCT No.: PCT/EP07/54749

§ 371 Date: Feb. 6, 2009

(30) Foreign Application Priority Data
May 18, 2006 (DE) 10-2006-023-743.9

(51) Int. Cl. C09J 7/00; B32B 37/00

(52) U.S. Cl. 156/280; 428/343; 428/354; 156/60

(57) ABSTRACT

A masking tape for use preferably in the two-tone painting of plastic components for external mounting incorporates a halogen-free film composed of polyolefins, specifically a mixture composed of a polypropylene or a polypropylene copolymer and of a further polymer, selected from the group of the polyethylenes or ethylene copolymers, the film, before or after coating with the adhesive, being irradiated with electron beams, with a dose between 5 and 100 kGy (Kilograys), and the weight fraction of polypropylene or of polypropylene copolymer being at least 20%, based on the entirety of the polyolefins.

The invention relates to the use of a halogen-free film in an adhesive masking tape, the film being tearable transversely as a result of electron beam irradiation, more particularly in an adhesive masking tape or in an adhesive masking sheet (below, the term adhesive (masking) tape also encompasses adhesive (masking) sheets) for masking purposes in order to obtain two-tone articles, in which at least one region of the article is closed off from painting by masking with the adhesive masking tape, and at the same time a sharp line of separation between painted and unpainted region is obtained.

The two-tone design of vehicles and particularly of vehicle components for external mounting is a design element of which frequent use is made. One method for generating such a design, established now for many years, is that of masking with adhesive masking tapes. Since plastic parts, and especially plastic bumpers, are frequently of two-tone design, and expand considerably at the temperatures at which the applied paints are dried, of up to 150° C., these tapes are generally composed of a plasticized PVC backing and a self-adhesive composition applied to one side thereof. Such tapes, in contrast to the paper tapes otherwise usual for painting purposes, follow the thermal expansion, whereas papers tend to shrink in the heat of the oven, owing to the drying.

The presently customary plasticized PVC tapes conform even to curved substrate contours and withstand the typical pretreatments of the plastic parts prior to painting, such as thorough pressure cleaning with hot wash solutions (“powerwash”) and the pretreatment of the cleaned plastic substrate with naked flames for the purpose of enhancing the adhesion of paint to the substrate. As already mentioned, they follow without problems the extension of the substrate, considerable in some cases, during paint drying, and can be removed without problems after the substrate is cooled, without tearing.

The major disadvantage of plasticized PVC adhesive tapes is the difficulty of disposing of them. Owing to the self-adhesive composition adhering to the masking tapes, and the residues of sprayed-on paint, it is not possible to pass such plasticized PVC adhesive tapes on for single-grain recycling, and they must therefore be incinerated, under complex and cost-intensive conditions, in order on the one hand to contain the risk of dioxine formation and on the other hand to clean the smoke gas from the gaseous hydrogen chloride formed.

Adhesive tapes based on the plasticized PVC film are described for example in GB 2,171,712 A. Conventional plasticized PVC adhesive tapes include a fraction of greater than 37 parts by weight of a phthalate-based monomer plasticizer to 100 parts by weight of the PVC polymer, which is generally not crosslinked. These plasticized PVC adhesive tapes then typically have an excessive breaking strength and breaking elongation, and this makes it difficult to tear off sections of the adhesive masking tape without tools such as scissors or knives.

DE 102 18 686 A1 discloses a film with easy hand tearability and good stretchability. The film contains 2 to 25 parts by weight of an additive polymer, in the form of an intrinsically crosslinked polymer or of a PVC-incompatible polymer, per 100 parts by weight of the PVC polymer, and 25 to 37 parts by weight of a polymer plasticizer per 100 parts by weight of the PVC polymer.

On account of the problems described there are concerns to produce adhesive masking tapes for two-tone painting that are composed of environment-friendly film materials which can be incinerated without problems. Among the first to come to mind are those composed of polyolefins, such as polyethylenes or polypropylenes, for example. Mimicking plasticized PVC properties with polyolefins is generally difficult, on account of the substantial differences between the two. Thus PVC is a substantially amorphous polymer, whereas the majority of polyolefins are partially crystalline. The flexibility needed from an adhesive masking tape for a bond which runs even around curves cannot be formulated by meterable amounts of external plasticizers as in the case of plasticized PVC, but instead can be formulated primarily via the degree of crystallinity of the polyolefin or of the polyolefin mixture.

The paint drying temperatures of up to 150° C. generally necessitate the presence of a polypropylene, since polyethylenes melt at no more than 140° C. and then contract sharply in the melted state and on recrystallization when cooling.

An approach of this kind is described in EP 0 823 467 B1, in which the film is constructed from a polymer alloy comprising a polypropylene and an olefin copolymer.

Good handling properties of an adhesive masking tape for two-tone painting include ease of transverse tearing by hand, since masking operations are often performed manually. Tools for cutting off defined lengths, such as scissors or cutting knives, for example, are unwanted, since there is a risk of injuries and damage, and since reaching for a tool entails a loss of time.

Many polyolefin films, being highly ductile, have poor transverse tearability. Although certain polyolefins can be formulated for better transverse tearability by means of alloying (blending) or filling with mineral fillers, they then tend, however, to tear easily when the masking tapes are removed after use.

US 2004/0086707 A1 discloses an adhesive tape which has a film backing. The film is composed of a mixture of
100 parts by weight of a polypropylene,
1 to 70 parts by weight of a polyethylene,
1 to 200 parts by weight of an inorganic filler, and
0.1 to 50 parts by weight of an adhesion promoter.
   The film is stretched in the lengthwise direction by a factor of 1.05 to 3.

Optionally a crosslinker is added, and the film is then subjected to electron beam crosslinking, the radiation dose being less than 2.5 MGy. In the examples, irradiation is carried out with 1 MGy.

The irradiation there serves to improve the temperature stability of the adhesive tape, as is evident from the descriptions accompanying examples 3, 4 and 11.

It is an object of the present invention to provide a film which is suitable as a backing film in, for example, an adhesive masking tape for two-tone painting, more particularly for the painting of plastic components for external mounting, and which does not have the disadvantages of the prior art that are known for relevant films, or not to the same extent. In particular, an adhesive masking tape produced using the film should be able to be incinerated in an eco-friendly way, useful for paint drying temperatures of up to 150° C., and amenable to transverse tearing by hand.

This object is achieved through the use of a film as recorded in the main claim. The dependent claims provide advantageous developments of the film.

The invention accordingly provides the use of a halogen-free film composed of polyolefins in a single-sided adhesive masking tape used preferably in the two-tone painting of plastic components for external mounting, the film being composed of a mixture comprising a polypropylene or a polypropylene copolymer and comprising a further polymer, selected from the group of the polyethylenes or ethylene copolymers, the film, before or after coating with the adhesive, being irradiated with electron beams, with a dose between 5 and 100 kGy (kilograys), and the weight fraction of polypropylene or of polypropylene copolymer being at least 20%, based on the entirety of the polyolefins.

According to one preferred embodiment of the invention, the further polymer is an ethylene-styrene copolymer or a copolymer of ethylene with polar comonomers such as acrylic acid, vinyl acetate or maleic anhydride.

The weight fraction of polypropylene or of polypropylene copolymer according to one advantageous embodiment of the invention is at least 40% based on the entirety of the polyolefins.

With further preference the weight fraction of polypropylene or of polypropylene copolymers is not more than 90%, with particular preference not more than 80%, with particular preference not more than 70%, based on the entirety of the polyolefins.

Particular preference is given to polypropylene block copolymers as polypropylene component.

The electron beam dose with which the film is irradiated is between 5 and 100 kGy (kilograys), preferably between 10 and 60 kGy.

The polyolefins which are not polypropylene or polypropylene copolymer are, for example, polyethylene or copolymers of ethylene. The copolymers of ethylene are composed of ethylene and of a monomer component which is copolymerizable with ethylene. The monomer component which is copolymerizable with ethylene is preferably an α-olefin of the formula CH₂═CHR¹, R¹ being an aliphatic group or an aromatic group having 1 to 8 carbon atoms.

The film of the invention is composed of polyolefins. In order to obtain sufficient temperature resistance in the sense of dimensional stability at temperatures up to 150° C., the film comprises polypropylene as homopolymer or polypropylene copolymers such as random polypropylene copolymers, in which a comonomer is distributed statistically over the chain. Ethylene is typically employed for that purpose. Typical random copolymers of polypropylene contain about 2 to 10 mol percent of ethylene. Also included, in the further sense, are ethylene-propylene copolymers (EPM) having molar ratios of about 30:70 to about 70:30 mol percent with respect to the random copolymers. In an even further sense, tercopolymers of ethylene, propylene, and dienes such as ethylidenenorbornene, dicyclopentadiene or 1,4-cyclooctadiene (EPDM), for instance, are also included. As comonomer to propylene use is likewise made of α-olefins of the formula CH₂═CHR¹, R¹ being an aliphatic group having 2 to 8 carbon atoms, including 1-butene, 1-hexene, 1-octene or 4-methyl-1-pentene.

Another class of polypropylene copolymers are the block copolymers, also referred to as heterophase polypropylenes, in which sequences of propylene homopolymer alternate with sequences of random polypropylene-ethylene copolymer. The elasticity modulus of the polypropylene block copolymers is between those of the propylene homopolymers and the random polypropylene copolymers.

The polypropylenes are alloyed with further polyolefins. Especially suitable are those from the group of the polyethylenes. This group encompasses homopolymers of ethylene such as high-pressure polyethylene (LDPE) and low-pressure polyethylene (HDPE), but also the copolymers of ethylene, especially those with α-olefins such as 1-butene, 1-hexene, 1-octene (depending on fraction and preparation process, called LLDPE, VLDPE or ULDPE or metallocene-PE), but also ethylene-styrene copolymers and copolymers of ethylene with polar comonomers such as acrylic acid, vinyl acetate or maleic anhydride.

Films of this kind are produced with the relevantly known methods, such as the chill roll method, in which the melt emerging from a sheet die is passed onto a chill roll, on which the melt solidifies to form a film. Another widespread method is the blown film method, in which the melt is extruded as a parison from an annular die and inflated to a greater or lesser extent, in order to obtain the desired dimensions (thickness and diameter) of the parison.

The melt is produced in extruders from plastic pellets. An extruder consists of a screw which rotates within a thermostatic jacket. The pellet mixture is drawn in at the rear end of the screw, melted by external heating, and conveyed with shearing to the end of the extruder, the various components being mixed intensely in accordance with the design of the screw. For this purpose a screw is composed of a number of zones, such as intake zone, compression zone, and metering zone, for example, sometimes with shearing section, decompression zone, and discharge zone, the latter likewise frequently with a mixing section. The helical movement of the melt within the screw generates a pressure in the direction of the front end that provides for the discharge of the melt into the dies described above.

For particularly intense mixing, twin-screw extruders are appropriate, in which two screws rotate in the same or opposite directions and so produce a particularly good mixing action.

For the above-described processing of polyolefins there are certain limits necessary for melt viscosities. Established practice is to report these in the form of the “Melt Flow Ratio” melt index (MFR) in accordance with ISO 1133. For polyolefins these ratios are usually given in g/10 min at 190° C. and a weight of 2.16 kg; for polypropylenes they are given correspondingly, but at a temperature of 230° C. Particularly suitable for the production of the film of the masking tape of the invention are polyolefins having an MFR under the abovementioned conditions of 0.5 to 15 g/10 min (190° C./2.16 kg in the case of polyethylenes or 230° C./2.16 kg in the case of polypropylenes).

In order to obtain specific film properties it is possible to extend the formula for the film with additives. These include, for example, fillers such as chalk, talc or titanium dioxide, or aging inhibitors based, for example, on amines or phenols, also in combination with secondary antioxidants such as phosphites and sulfites. Furthermore, light stabilizers based on sterically hindered amines (HALS) or UV absorbers, including benzotriazoles and benzophenones, may be advantageous. In order to scavenge metals that are catalytic by decomposition, metal deactivators may be advantageous, including hydrazines and hydrazides.

For optical design, use is to be made of dies or color pigments, also in conjunction with fillers, in order to obtain color transparency, translucency or opaque color.

Lubricants and antiblocking agents such as erucamide, oleamide, glyceryl monostearate, but also acid scavengers such as calcium stearate and other metal soaps can be used, provided they do not impair the adhesive properties of the self-adhesive composition, as a result of migration or of impression transfer from the reverse of the masking tape onto the self-adhesive composition.

According to one advantageous development, the breaking elongation of the film of the invention is more than 100% (tensioning speed: 300 mm per minute, temperature: 23±1° C., relative humidity: 50±5%) and/or the tensile stress at 1% elongation is 1 to 10 N/cm, preferably 1.5 to 6 N/cm.

In a further development of the invention the film may be given a multilayer design, either by coextrusion or by hot lamination or laminating with a laminate adhesive. Also embraced by the concept of the invention is the coating of the film with a different kind of polymer, such as polyamide, polyester or a polyethylene, for modifying lubricity properties or optical properties.

With further preference the film is unoriented. According to a further advantageous embodiment, no crosslinkers have been added to the film.

The film is coated on at least one side with an adhesive, preferably a self-adhesive composition.

Suitable self-adhesive compositions are in principle all common pressure-sensitive adhesive systems. These include reins-blended natural rubber self-adhesive compositions, acrylic ester copolymers (with and without addition of tackifier resins), synthetic rubber compositions (based for example on butyl rubber, polyisobutylene, styrene-butadiene copolymers, hydrogenated and nonhydrogenated styrene block copolymers, ethylene-propylene copolymers, amorphous poly-α-olefins, polyethylene-vinyl acetate copolymers or acrylate block copolymers), polyurethane pressure-sensitive adhesives and/or silicone pressure-sensitive adhesives.

Self-adhesive compositions may be applied from solution, from the melt or—where obtainable as such—in the form of an aqueous dispersion to the polyolefin film with suitable auxiliary coating means.

Particular suitability is possessed by highly cohesive self-adhesive compositions, with peel forces from steel of 1 to 8 N/cm in accordance with AFERA 5001, Method A.

The thicknesses in which the self-adhesive compositions are applied are preferably 5 to 100 g/m², more preferably 8 to 50 g/m².

All adhesives may be blended with plasticizers, tackifier resins or other additives such as aging inhibitors and fillers.

The anchoring of the self-adhesive composition may be enhanced by coating with a primer as an anchoring aid. Also serving for this purpose may be a corona pretreatment or a flame pretreatment of the side of the film that is to be coated.

The reverse of the adhesive tape may be coated with a reverse-face lacquer in order to exert a favorable influence over the unwound properties of the adhesive tape wound into an archimedean spiral. For this purpose this reverse-face lacquer may be equipped with silicone or fluorosilicone compounds and also with polyvinylstearylcarbamate, polyethyleneiminestearylcarbamide or organofluorine compounds as adhesive substances.

Optionally the adhesive tape may be presented as a diecut on a release paper or release film (typically, silicone-coated papers or polymeric films).

The general expression “adhesive tape” encompasses for the purpose of this invention all flat structures such as two-dimensionally extended films or film sections, tapes with extended length and limited width, tape sections, diecuts and the like.

The coating of the backing with primer and/or reverse-face varnish takes place with common coating methods such as doctor blade application or roll application, spraying methods or pouring methods. The self-adhesive composition can also be applied to the backing in a transfer method, in which the adhesive is coated onto an adhesive auxiliary backing and then, in the dried state, laminated onto the backing.

The film of the invention is highly suitable for use as a backing film in a masking tape which can be used for the two-tone painting of plastic components for external mounting.

The transverse hand tearability of the known films is generally not good. The requirement imposed on a masking tape for the two-tone painting of plastic components for external mounting is trouble-free transverse hand tearability, so that the masking operation is both rapid and does not involve any need to use a tool.

In order to achieve this, either the film of the invention, prior to further coating, or else the adhesive or masking tape already coated with self-adhesive composition, is irradiated with electron beams. For this purpose the film or the masking tape is conveyed in a single ply past an electron source which emits accelerated electrons having a kinetic energy of around 10⁵ to 10⁷ electron volts. For the irradiation of thin layers such as films, energies of up to 300 kilo-electron volts (keV) are typically employed. The accelerated electrons are generated in electron accelerators, scanning accelerators for example, which operate much like a TV tube, or in other constructions such as linear cathode accelerators or segmented cathode accelerators. for the effect on the film or the masking tape, the radiation dose absorbed is critical. Its SI unit is the Gray (Gy) or J/g, and thus it has the dimension of an energy density. Another important variable is the depth of penetration, which is a function of the kinetic energy, in other words of the acceleration voltage of the electron accelerator.

The electrons having the described kinetic energies that get into the web of material break chemical bonds, forming free radicals. These free radicals either recombine with other radicals or are eliminated by rearrangement reactions. Where the radicals are formed on the main chain of polymers, the reaction kinetics of the recombination reaction in competition with rearrangement, with scission of the polymer's main chain, determines whether there is polymer crosslinking or a reduction in molecular weight.

The transverse hand tearability can be improved in the sense of the invention at radiation doses of 5 to 100 kilograys (kGy), the dose to be used being dependent on the degree of desired tearability, the film formula, and the film thickness.

Surprisingly, the irradiation of the film of the above-described composition, or of the masking tape produced using it, with electron beams in a dose of 5 to 100 kGy leads to improved transverse hand tearability without critically impairing the tensile strengths, which are important for a functional masking tape in the contexts of adaptation to curving bond geometries and of demasking following application. The torn edge is also more even than without irradiation with electron beams.

The breaking elongation of the backing of the invention is preferably more than 100% (tensioning speed: 300 mm per minute, temperature: 23±1° C., relative humidity: 50±5%), so that, in the case of stretching to conform to curved bonding geometries, and during removal, there is no tearing of the masking tape. The tensile stress at 1% elongation is preferably 1 to 10 N/cm, more preferably 1.5 to 6 N/cm, in order to ensure ease of tearing when adapting to curves, and effective conformity to the substrate.

Prior to use, the adhesive tape with the film of the invention is typically unwound from a roll. It can be torn easily by hand transversely and with a straight torn edge in the required length, and applied along the desired paint edge to the component to be given the two-tone coating. Alternatively a diecut is peeled from the release medium (release film or release paper) and placed. By gentle pressing, the tape conforms well to the contours of the component, even through depressions or around curves. Masking can be supplemented by extensive adhesive films for nonadhesive flat materials such as polymeric films, metal foils or paper. The component may be cleaned together with the masking and prepared for painting by means of a primer or of pretreatment with a naked flame. The paint system, usually a multilayer system, is generally applied by automated spraying and freed from the solvent in drying installations of up to 150° C. for up to an hour. After cooling has taken place, the masking is removed. In this case there are no residues of self-adhesive composition as a result of contraction, and no tearing of the backing. Paint sprayed onto the reverse of the masking tape does not flake off on demasking.

The masking tape of the invention is additionally described below in a preferred version, using a number of examples, likewise without thereby wishing to subject to the invention to any restriction.

Also given are comparative examples, in which unsuitable masking tapes are presented.

### EXAMPLES

Parts below are by weight in each case.

### Example 1

On a laboratory film casting unit a film consisting of 60 parts of a polypropylene block copolymer having an MFR of 5.0 g/10 min (230° C.; 2.16 kg) and a melting point of about 160° C., and 40 parts of a low density polyethylene having an MFR of 2.0 g/10 min (190° C.; 2.16 kg) and a density of 927 kg/m³, together with 0.4 part of a primary antioxidant (Irganox 1010, Ciba) was extruded in a thickness of 90 μm and a useful width of 40 cm.

On a pilot unit, this film was pretreated on one side with a corona discharge to a surface energy of 48 mN/m and then coated with the solution of an acrylic ester copolymer as a self-adhesive composition so as to result in a coatweight of 25 g/m². The self-adhesive composition was a polymer of 40 parts of butyl acrylate, 40 parts of 2-ethylhexyl acrylate, 12 parts of vinyl acetate, 4.5 parts of methyl acrylate, 3 parts of acrylic acid, and 0.5 part of aluminum acetylacetonate.

Under a nitrogen atmosphere, the film was irradiated in an EBC unit with an acceleration voltage of 200 kV at a dose of 35 kGy, and then wound to a roll in full web width. Using a circular blade, narrow rolls were then slit off from the full-web-width roll by the parting method, for the tests.

### Example 2

Like example 1, but using for the film 50 parts of a polypropylene homopolymer having an MFR of 8.0 g/10 min (230° C.; 2.16 kg) and a melting point of about 164° C. and 50 parts of a low density polyethylene having an MFR of 2.0 g/10 min (190° C.; 2.16 kg).

### Example 3

Like example 2, but with the coated film irradiated with an EBC dose of 80 kGy.

### Example 4

Like example 1, but using for the film 50 parts of a polypropylene block copolymer having an MFR of 5.0 g/10 min (230° C.; 2.16 kg) and a melting point of about 160° C., 25 parts of a low density polyethylene having an MFR of 2.0 g/10 min (190° C.; 2.16 kg) and a density of 927 kg/m³, 20 parts of a linear low density polyethylene with 1-butene as comonomer, having an MFR of 1.2 g/10 min (190° C.; 2.16 kg) and a density of 919 kg/m³, and 5 parts of talc.

### Example 5

Like example 1, but with the 60 parts of a polypropylene block copolymer replaced by 40 parts of polypropylene homopolymer having an MFR of 8.0 g/10 min (230° C.; 2.16 kg) and a melting point of about 164° C. and 20 parts of random polypropylene copolymer having an MFR of 1.9 g/10 min (230° C.; 2.16 kg) and a melting point of about 145° C.

### Example 6

Like example 1, but with the film being run through the EBC unit and irradiated with electrons prior to being coated with adhesive.

### Counterexamples

### Counter Example 1

Like example 1, but with the film composed of 40 parts of a low density polyethylene having an MFR of 2.0 g/10 min (190° C.; 2.16 kg) and a density of 927 kg/m³ and 60 parts of a linear low density polyethylene with 1-butene as comonomer, having an MFR of 1.2 g/10 min (190° C.; 2.16 kg) and a density of 919 kg/m³.

### Counter Example 2

Like example 1, but the film was composed of 40 parts of a polypropylene homopolymer having an MFR of 8.0 g/10 min (230° C.; 2.16 kg) and a melting point of about 164° C. and 60 parts of random polypropylene copolymer having an MFR of 1.9 g/10 min (230° C.; 2.16 kg) and a melting point of about 145° C.

### Counter Example 3

Like example 1, but the coated film was not irradiated with EBC radiation.

### Counter Example 4

Like example 6, but the EBC irradiation was omitted.

### Counter Example 5

Like example 1, but irradiation took place with a 130 kGy EBC dose.

### Test Criteria

The decisive test criteria employed for determining the suitability of a masking tape for the two-tone painting of plastic components, with a halogen-free backing, were as follows:
peel force from plastic component
transverse hand tearability
thermal contraction in the bonded state
demaskability after overpainting and paint drying
contour of the paint edge

### Implementation of the Tests

Peel Force from Plastic Component

The peel force measurement was conducted by a method based on AFERA test method 5001, Method A. Instead of a steel plate, the application-relevant substrate used was a PP plastic plate with an embossed surface with a roughness R_{z} of 50 μm. Prior to use, the plate was cleaned with methyl ethyl ketone.

### Transverse Hand Tearability

Strips of the example specimen 15 mm wide were torn transverse to the machine direction (from the film extrusion standpoint) by three individuals ten times by hand or an attempt was made to tear them thus by hand. The parameter determined was the average value of the total of thirty subjective evaluations per example specimen. The evaluation scheme for the degree of transverse hand tearability is as follows:
Δ=easily tearable with straight torn edge
O=moderately tearable with stretched torn edge
X=difficult to tear or untearable, severely stretched torn edge

### Thermal Contraction in the Bonded State

Strips of the example specimen 15 mm wide and 15 cm long (in machine direction) were adhered to an aluminum panel and pressed on with a pressure roller, as described in the AFERA method 5001. Using a cutter, the strips were severed centrally, perpendicularly with respect to the lengthwise direction, down to the aluminum panel base. This was followed by thermal exposure at 150° C. for one hour in a thermal cabinet. The contraction, in the form of the widening of the gaps, was determined at an incision as follows:
Δ=gap<1 mm
O=gap>1 mm
X=gap>>1 mm and turning-up of the film ends.

### Demaskability After Overpainting and Paint Drying

Strips of the example specimen 15 mm wide and 15 cm long were adhered to a smooth PP plastic plate and pressed on with a pressure roller, as described in the AFERA method 5001. The plates to which bonding had taken place were subjected for 2 seconds to a naked flame of a Bunsen burner and then spray-painted with a two-component clear paint in a film thickness of 50 μm (Evergloss 8610, FF98-0017, BASF). The plates were dried at 145° C. for 25 minutes.

After they had cooled to room temperature, the strips were demasked at an angle of 90° C. The test criterion was the removability of the tape strips without tearing. The removability was evaluated in accordance with the following scheme:
Δ=no tearing
X=occasional or frequent tearing

### Contour of the Paint Edge

The PP plates identified in the section headed Demaskability after overpainting and paint drying were tested, following the removal of the tapes, for the uniformity of the contour of the paint edge, with the following assessment criteria:
Δ=very precise, uniform paint edge
O=moderately precise paint edge
X=imprecise, nonuniform paint edge

### Results

The table of results below summarizes the results of the tests. OK (satisfactory) means that the overall assessment is positive, and the specimen is appropriate for the application; n.OK (not satisfactory) means that the overall assessment is negative, and the specimen is not appropriate for application.

Results table

| | Peel force | | | | Contour | |
|---|---|---|---|---|---|---|
| | from plastic | Transverse | Thermal | | of paint | Overall |
| | [N/cm] | hand tearability | contraction | Demaskability | edge | assessment |
| Example 1 | 2.2 | Δ | Δ | Δ | Δ | OK |
| Example 2 | 2.3 | Δ | Δ | Δ | Δ | OK |
| Example 3 | 2.1 | Δ | Δ | Δ | Δ | OK |
| Example 4 | 2.2 | Δ | Δ | Δ | Δ | OK |
| Example 5 | 2.4 | Δ | Δ | Δ | Δ | OK |
| Example 6 | 2.5 | Δ | Δ | Δ | Δ | OK |
| Comparative | 2.7 | X | X | Δ | X | n.OK |
| Example 1 | | | | | | |
| Comparative | 2.2 | Δ | Δ | X | Δ | n.OK |
| Example 2 | | | | | | |
| Comparative | 2.6 | X | ◯ | Δ | ◯ | n.OK |
| Example 3 | | | | | | |
| Comparative | 2.7 | X | ◯ | Δ | ◯ | n.OK |
| Example 4 | | | | | | |
| Comparative | 2.9 | Δ | Δ | X | Δ | n.OK |
| Example 5 | | | | | | |

As is evident from the results table, the tapes of the examples meet the essential test criteria relevant for a masking tape for two-tone painting.

These exemplary masking tapes exhibit an application-compatible peel force from a typical plastic substrate, can easily be torn transversely by hand during application to separate off a length, with a smooth torn edge, do not exhibit any significant thermal contraction in the course of paint drying, can be demasked easily and without tearing, and leave behind a very accurate paint edge.

The absence of PVC makes it possible, after use, to carry out unproblematic, eco-friendly disposal, including by incineration, since there is no toxic hydrogen chloride given off.

1. A masking tape comprising a halogen-free film and an adhesive applied to one side of said film, the halogen-free film being composed of a mixture of polyolefins comprising a polypropylene or a polypropylene copolymer and comprising a further polymer, the further polymer being selected from the group of the polyethylenes or ethylene copolymers, the film, before or after application of the adhesive, being irradiated with electron beams, with a dose between 5 and 100 kGy (kilograys), and the weight fraction of polypropylene or of polypropylene copolymer being at least 20%, based on the entirety of the polyolefins.

2. The masking tape as claimed in claim 1, wherein the weight fraction of polypropylene or of polypropylene copolymer is at least 40%, based on the entirety of the polyolefins.

3. The masking tape as claimed in claim 1, wherein the polypropylene block copolymers are used as polypropylene component.

4. The masking tape as claimed in claim 1, wherein the further polymer is an ethylene-styrene copolymer or a copolymer of ethylene with polar comonomers.

5. The masking tape as claimed in claim 1, wherein the copolymers of ethylene are composed of ethylene and of a monomer component which is copolymerizable with ethylene.

6. The masking tape as claimed claim 1, wherein the polyolefins have an MFR of 0.5 to 15 g/10 min (190° C. and 2.16 kg in the case of polyethylenes, 230° C. and 2.16 kg in the case of polypropylenes).

7. The masking tape claimed in claim 1, which exhibits a breaking elongation of more than 100% (tensioning speed: 300 mm per minute, temperature: 23±1° C., relative humidity: 50±5%) and/or a tensile stress at 1% elongation of 1 to 10 N/cm.

8. The masking tape as claimed in claim 1, wherein the film is composed of two or more layers.

9. The masking tape as claimed in claim 1, wherein the film is unoriented.

10. The masking tape as claimed in claim 1, wherein the film is free of crosslinkers.

11. A method of masking a substrate, which comprises applying a masking tape as claimed in claim 1 to said substrate.

12. A method of painting a substrate, which comprises masking a portion of the substrate by applying a masking tape as claimed in claim 1 to said substrate, and thereafter painting another portion of said substrate to which said masking tape is not applied.
